(19) United States
(12) Patent Application Publication
(10) Pub. No.: US 2007/0121613 A1
(43) Pub. Date: May 31, 2007

(54) Automatic allocation of prefixes to equipments of an ipv6 communication network

(76) Inventors: Laurent Clevy, Chartres (FR); Philippe Bereski, Morsang Sur Orge (FR); Bruno Mongazon-Cazavet, St Michel-Sur-Orge (FR)

Correspondence Address: SUGHRUE MION, PLLC, 2100 PENNSYLVANIA AVENUE, N.W., SUITE 800, WASHINGTON, DC, 20037, US

(21) Appl. No.: 10/587,942

(22) PCT Filed: Feb. 1, 2005
(86) PCT No.: PCT/FR05/00218

§ 371 Date: Sep. 14, 2006

(30) Foreign Application Priority Data
Feb. 2, 2004 (FR) 0450185

(51) Int. Cl. H04L 12/56

(52) U.S. Cl. 370/389

(57) ABSTRACT

A communication equipment for an Internet Protocol communication network including a set of interfaces each connected to one or more other communication equipments and having means for receiving an address prefix from a first other communication equipment. It further includes allocation means for allocating to at least a portion of the other communication equipments to which the first other equipment does not belong a sub-prefix formed of the address prefix concatenated with an individual identifier whose length depends on the total number of other communication equipments.

### CROSS-REFERENCE TO RELATED APPLICATIONS

This application is based on French Patent Application No. 0450185 filed Feb. 2, 2004, the disclosure of which is hereby incorporated by reference thereto in its entirety, and the priority of which is hereby claimed under 35 U.S.C. § 119.

### BACKGROUND OF THE INVENTION

1. Field of the Invention

The present invention relates to Internet Protocol type communication networks, more precisely communication networks based on the IPv6 (Internet Protocol-version 6) protocol stack. It relates more particularly to the automatic configuration of a network of this kind.

2. Description of the Prior Art

A network of this type consists of a set of equipments, generally referred to as “routers”, whose role is to route data traffic between a sender and a destination. Each network equipment has one or more interfaces each of which is used to communicate with one or more other network equipments.

In the appended FIG. 1, the equipment R_{A} has two interfaces I_{A1} and I_{A2}. The interface I_{A2} is used to communicate with a single equipment R_{D} via its interface I_{D}. The interface I_{A1} is used to communicate with two equipments R_{B} and R_{C} connected to the same link via their respective interfaces I_{B} and I_{C}. In reality, the equipment or router has at least two or three interfaces. It must therefore choose to “switch” each incoming data packet from one of its interfaces to one or the other of its other interfaces. This choice is not trivial. The mechanism for making this choice is referred to as “routing”.

In order to be able to route traffic correctly from one point to another, each network equipment has access to a routing table establishing the correspondence between a set of addresses and an output interface: accordingly, an equipment receiving a data packet having such and such a destination address is able to determine to which of its interfaces it must send it.

It is therefore necessary, before a communication network can route data traffic in this way, to effect a step of configuring the network during which, among other things, addresses must be allocated to each of the interfaces of each of the network equipments, and then to construct the routing table.

The specifications of an IPv6 network are set out in the document RFC 2460 of the IETF (Internet Engineering Task Force). The document “IP Version 6 Addressing Architecture” (draft-ieft-ipv6-addr-arch-v4-00.txt) more particularly specifies the composition of the addresses of these interfaces.

There are several address types, but only “global unicast” addresses are relevant here, i.e. those addresses uniquely identifying an interface of a communication equipment in a network. In the case of the network known as the “Internet” linking a plurality of subnetworks worldwide, this unique characteristic is required at the global level. These “global unicast” addresses are referred to hereinafter simply as “global addresses” to clarify the text.

An address of this type consists of two main parts, a first part typically of 64 bits and a second part typically of 64 bits, the global address then occupying 128 bits in total.

The second part consists of a unique identifier of the interface. The composition of this part is specified in paragraph 2.5.1 of the document “IP Version 6 Addressing Architecture”. It may consist of a universal identifier, for example of the type defined by the IEEE 802 MAC (“Media Access Control”) standard or the IEEE EUI-64 (Extended Universal Identifier) standard.

The second part can easily be determined autonomously and automatically by each network equipment.

However, there is no automatic method for a network equipment to determine the first part, generally referred to as the “network number”.

At present, in IPv6 type networks, this part is determined manually by an operator responsible for configuring the network. The operator connects to each network equipment to allocate it a global address for each interface, ideally in accordance with an optimized addressing plan. This kind of addressing plan may conform to the methodology described in RFC 3177 “IAB/IESG Recommendations on IPv6 Address Allocations to Sites”.

This manual allocation of global addresses has many drawbacks. In particular, it takes a long time, requires a team of specialized technicians and does not facilitate reconfiguring the topology of the network or adding a new equipment to an existing network. Most importantly, it is liable to generate errors as the technicians are fallible, however skilled they may be (human error). The larger the network, the greater the number of errors, which are therefore difficult to detect and then to correct.

A need has become apparent to automate the configuration of communication networks and amongst other things the allocation of global addresses.

A first step towards this automation is disclosed in the document “Automatic Prefix Delegation Protocol for Internet Protocol Version 6 (IPv6)” by B. Haberman and J. Martin (draft-haberman-ipngwg-auto-prefix-02.txt) published in February 2002 and the document “Hierarchical Prefix Delegation Protocol for Internet Protocol Version 6 (IPv6)” by Byung-Yeob Kim, Kyeong-Jin Lee, Jung-Soo Park and Hyoung-Jun Kim (draft-bykim-ipv6-hpd-00.txt) published in October 2003. The above two documents are IETF drafts with the file names indicated in brackets above available on the website of the IETF (Internet Engineering Task Force).

These documents disclose automatically allocating a network equipment an address prefix based on an address prefix supplied by another network equipment. The latter is called the address delegator and the mechanism itself is called address delegation.

However, a mechanism of the above kind is inadequate in that it does not take account of the topology of the existing communication network.

The applicant has become aware that it is important to take account of this topology, for the following reason at least: each equipment has a routing table enabling it to route incoming data packets correctly. Limiting the size of these routing tables saves on storage resources in the equipments and shortens the search time each time that a data packet is received. The applicant has become aware that taking account of the topology of the network for optimum allocation of address prefixes to the equipments is important and can lead to a significant reduction in the size of the routing tables, thereby increasing the performance of the communication equipment.

### SUMMARY OF THE INVENTION

The invention consists in a communication equipment for an Internet Protocol communication network, including a set of interfaces each of which is connected to one or more other communication equipments, means for receiving an address prefix from a first other communication equipment, and allocation means for allocating to at least a subset of the other communication equipments to which the first other communication equipment does not belong a sub-prefix formed of the address prefix concatenated with an individual identifier whose length depends on the total number of other communication equipments.

Accordingly, by making the sub-prefixes “depend” on a received prefix, the invention creates a hierarchy of sub-prefixes taking account of the topology of the network and limiting the size of the routing tables.

A further advantage of the invention is that it optimizes the use of the resource consisting of the number of bits available for network numbers: using for each equipment only the necessary number of address bits therefore represents a saving.

The invention and other advantages thereof will become more clearly apparent in the light of the following description with reference to the appended drawings.

### BRIEF DESCRIPTION OF THE DRAWINGS

FIG. 1, commented on above, is a diagram of a communication network comprising four equipments.

FIG. 2 shows the format of an address prefix according to the invention.

FIG. 3 is a diagram of a communication network showing the execution on that network of the method described.

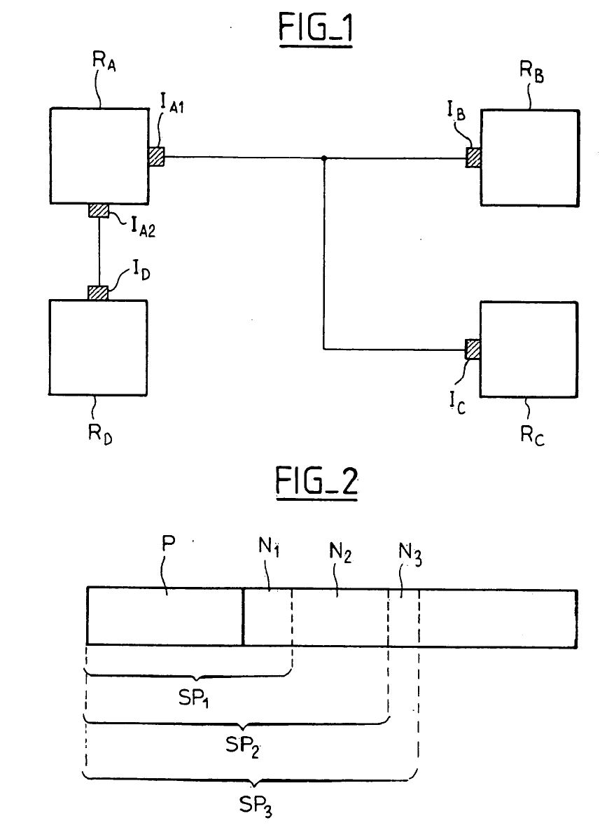

### DETAILED DESCRIPTION OF THE PREFERRED EMBODIMENT

A communication equipment or router according to the invention includes allocation means for allocating a sub-prefix to at least some of the communication equipments connected to it.

FIG. 2 explains how sub-prefixes are allocated in accordance with the invention.

An initial prefix P is allocated to a first communication equipment by manual configuration or by any other means (this process is outside the scope of the present patent application).

This first equipment then assigns a sub-prefix SP₁ to at least a subset of the equipments to which it is connected. This sub-prefix SP₁ comprises a prefix P and a part N₁. This part N₁ is an individual identifier of the equipment concerned: it distinguishes the equipments from each other within this subset of the connected equipments.

According to the invention, the size of this part N₁ (i.e. the number of bits) depends on the number of equipments on the subset of connected equipments for which a sub-prefix must be allocated. If x denotes this number, then the size of the field N₁ must be log₂(x) bits.

For example, if the first equipment has four equipments to which a sub-prefix must be allocated, then the field N₁ must be of size log₂(4)=2, and the following sub-prefixes may be used, for example (the notation indicates that the prefix P is concatenated with the subsequent two bits):

P:00

P:01

P:10

P:11

Each of these equipments therefore receives a different sub-prefix SP₁ (identical prefix P but different part N₁). These equipments then proceed in the same manner and determine sub-prefixes SP₂ for other communication equipments. These sub-prefixes similarly consist of the sub-prefixes SP₁ (considered as prefixes, as it were) and different individual identifiers N₂ for each of the equipments, the size of which depends on their number.

Similarly, these equipments in turn allocate sub-prefixes SP₃ consisting of the sub-prefixes SP₂ and individual identifiers N₃.

The process continues progressively in this way until sub-prefixes have been allocated to the whole of the communication network.

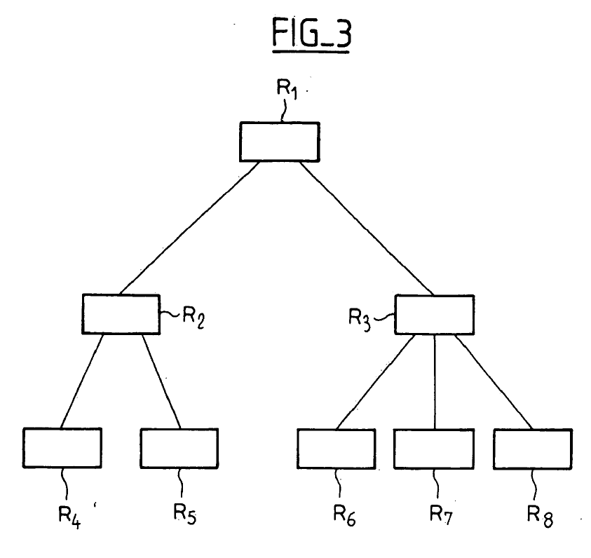

FIG. 3 shows this allocation process in more detail in relation to a more concrete example.

The equipment R₁ acquires a prefix by a method that is outside the scope of this patent application.

This prefix is 4001:0660:3510::0/48, for example. The meaning of this format is explained in the documents cited above on address formats in the IPv6 protocol. It is nevertheless important to note that here the “/48” indicates the length in bits of the prefix, which is 64 bits maximum. The symbols “:” are merely separators for convenience of reading and the symbol “::” indicates that sufficient “0” are inserted to pad out the prefix to the indicated 48 bits (thus a single symbol “::” is possible).

This network equipment R₁ has “son” equipments R₂ and R₃ to which it must allocate sub-prefixes. As there are two of these son equipments, a single bit is necessary for the individual identifier (log₂ (2)=1). The equipment R₂ will have the value “0” for its individual identifier and the equipment R₃ will have the value “1”.

Consequently, the respective sub-prefixes of the equipments R₂ and R₃ are:

4001:0660:3510:0000::0/49

4001:0660:3510:8000::0/49

Note that the sub-prefixes are one bit longer than the initial prefix. The second sub-prefix has the value “8” in thirteenth position, i.e. “1000” in binary. This “1” corresponds to the individual identifier of the equipment R₃.

The equipment R₂ proceeds in exactly the same way and therefore allocates sub-prefixes depending on the sub-prefix of R₂ to its “son” equipments R₄ and R₅. These sub-prefixes are respectively:

4001:0660:3510:0000::0/50

4001:0660:3510:4000::0/50

For the second prefix, the value “4” in thirteenth position is written “0100” in binary. The first “0” is the individual identifier of the equipment R₂ and the subsequent “1” is that of the equipment R₅.

The equipment R₃ has three son equipments to which it must allocate a sub-prefix. Two bits are therefore necessary for allocating an individual identifier to these three equipments R₆, R₇ and R₈, taking the values “00”, “10” and “11”, respectively.

The respective sub-prefixes are therefore:

4001:0660:3510:8000::0/51

4001:0660:3510:C000::0/51

4001:0660:3510:E000::0/51

For the third sub-prefix, for example, the value “E” is written “1110” in binary. The first “1” represents the individual identifier of the equipment R₃ and the subsequent two bits “11” constitute the individual identifier of the equipment R₈.

The communication equipments of the invention allocate sub-prefixes in an optimized manner. This implies at least two significant advantages:
Firstly, by increasing the size of the sub-prefixes by only the strictly necessary length, the mechanism of the invention economizes on the resource represented by the address prefix. The increase in the number of bits used is limited on each step, and it is therefore possible to descend lower in the tree formed by a network, and therefore to allocate a sub-prefix to a greater number of communication equipments.
Secondly, the invention allocates prefixes that can be “aggregated”: the prefix of each equipment contains the prefix of its “father” equipment.

For example, in FIG. 3, the equipment R₇ contains the prefix of the equipment R₃ and therefore, by recurrence, of the equipment R₁.

Consequently, the equipment R₁ does not need to store in its routing table as many entries as it has “grandsons”: as many entries as there are “sons” suffices, i.e. two rather than five.

If a data packet carries an address containing the prefix of the equipment R₇, to route it correctly it suffices to have in its routing table an entry corresponding to the prefix of the equipment R₃.

This property is extremely beneficial as it minimizes the size of the routing table and thereby improves the performance of the communication equipments.

1. A communication equipment for an Internet Protocol communication network, including a set of interfaces each of which is connected to one or more other communication equipments, means for receiving an address prefix from a first other communication equipment, and allocation means for allocating to at least a subset of said other communication equipments to which said first other communication equipment does not belong a sub-prefix formed of said address prefix concatenated with an individual identifier whose length depends on the total number of other communication equipments.

2. A communication equipment according to the preceding claim compatible with a protocol of the IPv6 type.

3. A method of allocating prefixes in an Internet Protocol type communication network in which a communication equipment has a set of interfaces each of which is connected to one or more other communication equipments and means for receiving an address prefix from a first other communication equipment, in which method the communication equipment allocates to at least a subset of said other communication equipments to which said first other equipment does not belong a sub-prefix formed of said address prefix concatenated with an individual identifier whose length depends on the total number of other communication equipments.
